(19) United States
(12) Patent Application Publication
(10) Pub. No.: US 2013/0029356 A1
(43) Pub. Date: Jan. 31, 2013

(54) METHODS AND SYSTEMS FOR USING DRUGS AS BIOMARKERS

(71) Applicant: Jackie L. Stilwell, Sammamish, WA (US)

(72) Inventor: Jackie L. Stilwell, Sammamish, WA (US)

(21) Appl. No.: 13/558,908

(22) Filed: Jul. 26, 2012

Related U.S. Application Data
(60) Provisional application No. 61/511,623, filed on Jul. 26, 2011.

(51) Int. Cl. G01N 21/64; G01N 21/78; B82Y 15/00

(52) U.S. Cl. 435/7.23; 436/501; 435/7.2; 435/7.32; 977/774; 977/920

(57) ABSTRACT

Methods and systems for using drugs as biomarkers to investigate the status of biological systems are disclosed. A drug is conjugated with a light emitting dye that emits light in a channel of the electromagnetic spectrum when an appropriate stimulus is applied. In one aspect, a suspension suspected of containing target particles is added to a tube along with the conjugated drug/dye complex and a float. Centrifugation of the tube, float, and suspension causes various components to separate along the axial length of the tube. Binding of the drug/dye complex to the target particles can be assessed by applying an appropriate stimulus to the tube, which, in turn, causes the fluorescent dyes to emit light in the channel. The level of fluorescence of the target particles located between the float and the inner wall of the tube can be used to assess use of the drug in therapy.

### CROSS-REFERENCE TO A RELATED APPLICATION

This application claims the benefit of Provisional Application No. 61/511,623; filed Jul. 26, 2011.

### TECHNICAL FIELD

This disclosure relates to systems and methods for detecting biomarkers in bodily fluid samples.

### BACKGROUND

A tissue sample of a patient suffering from a serious illness, such as cancer, can be analyzed for the presence of abnormal organisms or cells in order to identify causes of the illness and determine if the patient's condition is changing with therapy. However, detecting abnormal organisms or cells in certain tissues can be difficult and expensive, because it is often not practical to collect tissue samples to assess the effectiveness of a drug therapy intended to target the abnormal organism or cells using conventional tissue analyzing techniques. Instead the effectiveness of a drug therapy is typically assessed by monitoring a patient's symptoms over time, which may ultimately prove to be detrimental to the patient, because the abnormal organisms or cells may evolve so that the drug is no longer effective. As a result, the patient's condition may worsen while the patient is treated with an ineffective drug therapy that may also have debilitating side effects. Practitioners, researchers, and those working with patients suffering from serious illnesses continue to seek methods and systems for readily assessing whether or not a particular drug therapy continues to be effective at treating a patient's illness.

### DESCRIPTION OF THE DRAWINGS

FIGS. 1A-1B show isometric views of two example tube and float systems.

FIGS. 2-5 show examples of different types of floats.

FIG. 6 shows a flow diagram of an example method of using a drug as a biomarker.

FIGS. 7A-7C show example representations of a target particle and a drug/dye complex.

FIG. 8 shows an example of a centrifuged suspension composed of anticoagulated whole blood.

FIG. 9 shows an example of a centrifuged suspension composed of anticoagulated whole blood.

FIG. 10 shows an example of a bar graph of two hypothetical integrated intensities.

FIG. 11 shows an example of a centrifuged suspension composed of anticoagulated whole blood.

FIGS. 12A-12B shows an example of a slide and cover slip used to capture images of a suspension combined with a drug/dye complex.

FIG. 13 shows six images of individual cancer cells of six different cancer cell lines treated with the same drug/dye complex.

FIG. 14 shows a bar graph of integrated intensities measured from images of three cancer cell lines combined with the same drug/dye complex.

### DETAILED DESCRIPTION

Methods and systems for using drugs as biomarkers to investigate the status of biological systems are disclosed. A drug to be used as a biomarker is conjugated with a fluorescent dye that emits light over a particular very narrow wavelength range of the electromagnetic spectrum when an appropriate stimulus is applied. The drug/dye complex functions as a biomarker in that the drug component can be a compound, nucleic acid, or protein (i.e. an antibody) that attaches to the outer membrane of a target particle, which can be a cell, vesicle, liposome, bacterium, or a naturally occurring or artificially prepared microscopic unit. The drug may alter the properties and internal processes of the target particle. In one aspect, a suspension suspected of containing target particles is combined with a conjugated drug/dye complex and is added to a tube along with a float. The float has a specific gravity selected so that the float is positioned at approximately the same level as the target particles when the tube, float and blood sample are centrifuged together. Centrifugation of the tube, float, and suspension causes various components to separate along the axial length of the tube according to their associated specific gravities. When target particles are present in the suspension, the target particles are located between the outer surface of the float and the inner wall of the tube. Binding of the drug/dye complex to the target particles can be assessed by applying an appropriate stimulus to the tube, which, in turn, causes the fluorescent dyes to emit light. The fluorescence-intensity levels of the target particles located between the float and the inner wall of the tube can be used to assess if the drug can bind to its target.

A general description of tube and float systems is provided in a first subsection followed by a description of method embodiments in a second subsection An example of using a drug as a biomarker is described in a third subsection.

### Tube and Float Systems

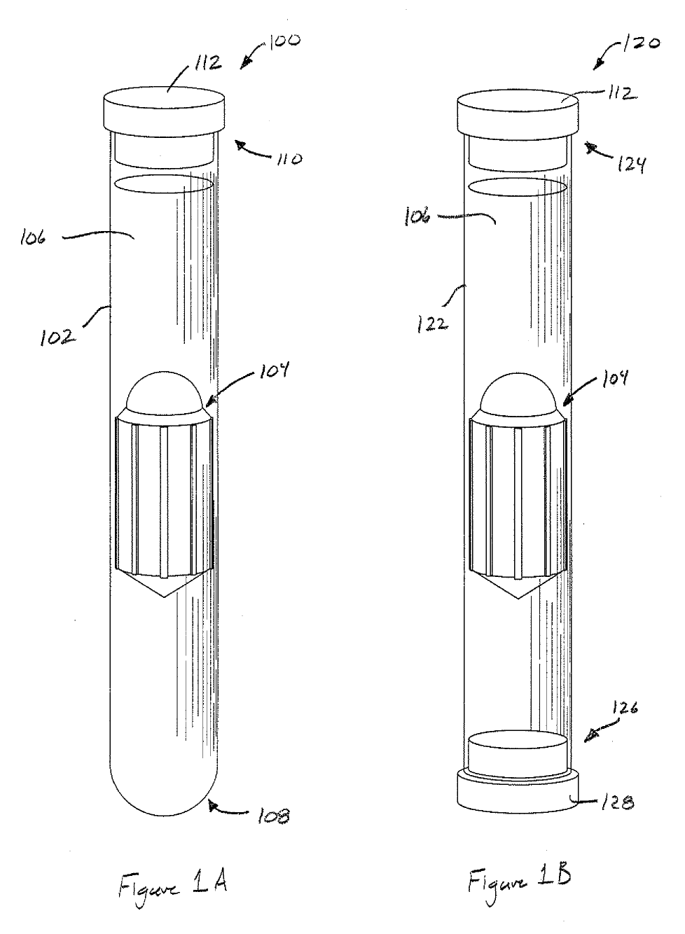

FIG. 1A shows an isometric view of an example tube and float system 100. The system 100 includes a tube 102 and a float 104 suspended within a suspension 106. In the example of FIG. 1A, the tube 102 has a circular cross-section, a first closed end 108, and a second open end 110. The open end 110 is sized to receive a stopper or cap 112. FIG. 1B shows an isometric view of an example tube and float system 120. The system 120 is similar to the system 100 except the tube 102 is replaced by a tube 122 with two open ends 124 and 126 configured to receive the cap 112 and a cap 128, respectively. The tubes 102 and 122 have a generally cylindrical geometry, but may also have a tapered geometry that widens toward the open ends 110 and 124, respectively. In other embodiments, the tubes 102 and 122 can have elliptical, square, triangular, rectangular, octagonal, or any other suitable cross-sectional shape that substantially extends the length of the tube. The tubes 102 and 122 can be composed of a transparent or semitransparent flexible material, such as a flexible plastic.

FIG. 2A shows an isometric view of the float 104 shown in FIG. 1.

The float 104 includes a main body 202, a cone-shaped tapered end 204, a dome-shaped end 206, and splines 208 radially spaced and axially oriented on the main body 202. The splines 208 provide a sealing engagement with the inner wall of the tube 102. In alternative embodiments, the number of splines spline spacing, and spline thickness can each be independently varied. The splines 208 can also be broken or segmented. The main body 202 is sized to have an outer diameter that is less than the inner diameter of the tube 102, thereby defining fluid retention channels between the main body 202 and the inner wall of the tube 102. The surfaces of the main body 202 between the splines 208 can be flat, curved or another suitable geometry. In the example of FIG. 2, the splines 208 and the main body 202 form a single structure. FIG. 2B shows a side view of a float 210 with rings 212 that wrap circumferencially around the main body 214. The rings 212 have approximately equal diameters that are greater than the diameter of the main body 214. The rings 212 may be separately formed and attached to the main body 214, or the rings 212 and the main body 214 can form a single structure. The rings 212 are sized to be approximately equal to, or slightly greater than, the inner diameter of the tube 102, and the body 214 is sized to have an outer diameter that is less than the inner diameter of the tube 102, thereby defining annular-shaped gaps 216 between the outer surface of the body 214 and the interior sidewall of the tube 102. The body 214 occupies much of the cross-sectional area of the tube 102 with the annular gaps 216 are sized to substantially contain a target material.

Embodiments include other types of geometric shapes for float end caps. FIG. 3 shows an isometric view of an example float 400 with a cone-shaped end cap 302 and a dome-shaped end cap 304. The main body 306 of the float 300 includes the same structural elements (i.e., splines) as the float 104. A float can also include two dome-shaped end caps or two cone-shaped end caps. The float end caps can include other geometric shapes and are not intended to be limited the shapes described herein.

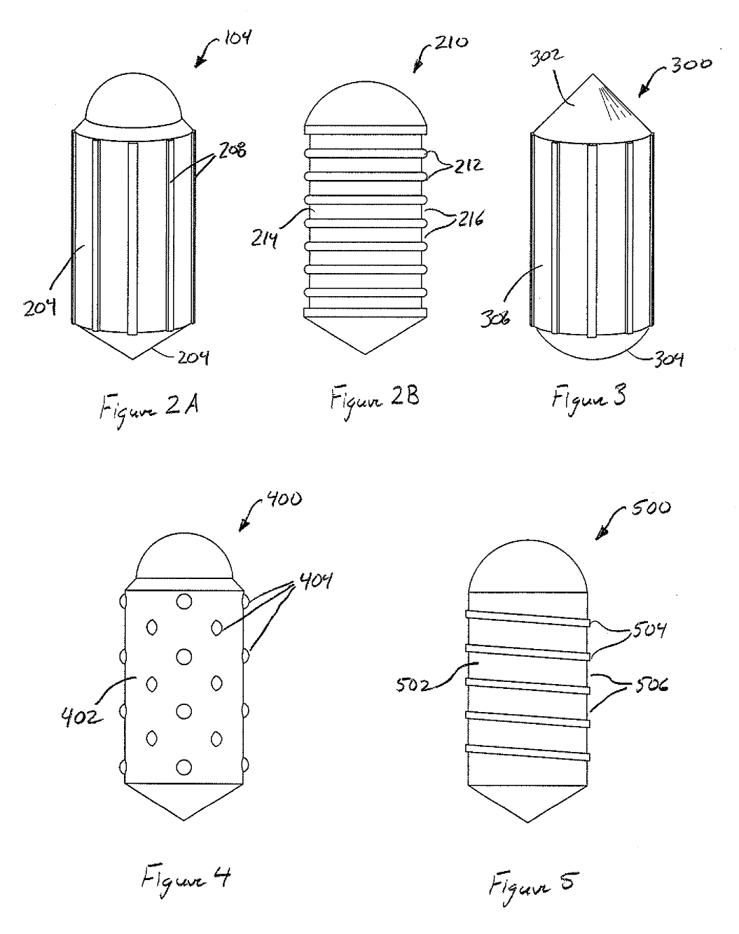

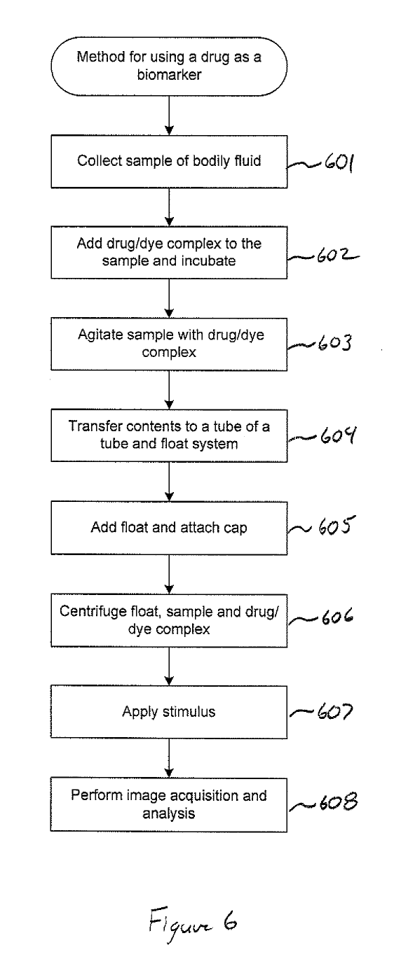

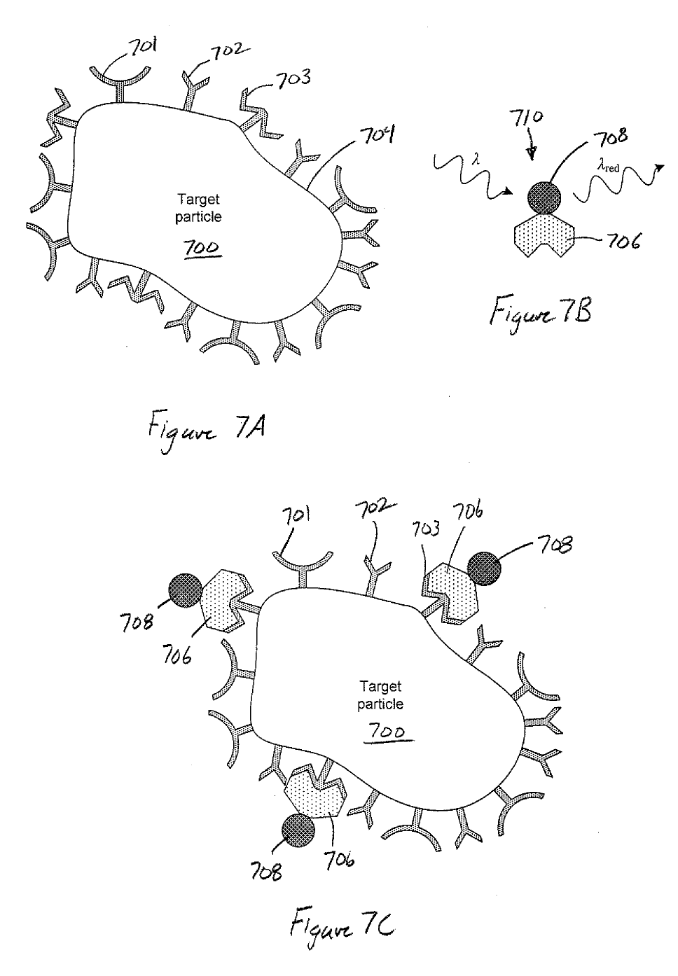

In other embodiments, the main body of the float 104 can include a variety of different support structures for separating target particles, supporting the tube wall, or directing the suspension fluid around the float during centrifugation. FIGS. 4 and 5 show examples of two different types of main body structural elements. In FIG. 4, the main body 402 of a float 400 is similar to the float 104 except the main body 402 includes a number of protrusions 404 that provide support for the deformable tube. In alternative embodiments, the number and pattern of protrusions can be varied. In FIG. 5, the main body 502 of a float 500 includes a single continuous helical structure or ridge 504 that spirals around the main body 502 creating a helical channel 506. In other embodiments, the helical ridge 504 can be rounded or broken or segmented to allow fluid to flow between adjacent turns of the helical ridge 504. In various embodiments, the helical ridge spacing and rib thickness can be independently varied. Embodiments are not intended to be limited to these two examples.

The float can be composed of a variety of different materials including, but not limited to, rigid organic or inorganic materials, and rigid plastic materials, such as polyoxymethylene (“Delrin®”). Other types of tube and float systems that can be used to execute methods described herein are described in U.S. Provisional Patent Applications 61/448,277 filed Mar. 2, 2011 and 61/473,602 filed Apr. 8, 2011 and are incorporated by reference.

### Using Drugs as Biomarkers

Methods for using a drug as a biomarker are now described. For the sake of convenience, the methods are described with reference to an example suspension of anticoagulated whole blood. But the methods described below are not intended to be so limited in their scope of application. The methods, in practice, can be used with any kind of drug/dye complex as a biomarker in any kind of suspension and are not intended to be limited to drugs designed to interact with components found only in whole blood. For example, a sample suspension can be stool, semen, cerebrospinal fluid, nipple aspirate fluid, saliva, amniotic fluid, vaginal secretions, mucus membrane secretions, aqueous humor, vitreous humor, vomit, and any other physiological fluid or semi-solid.

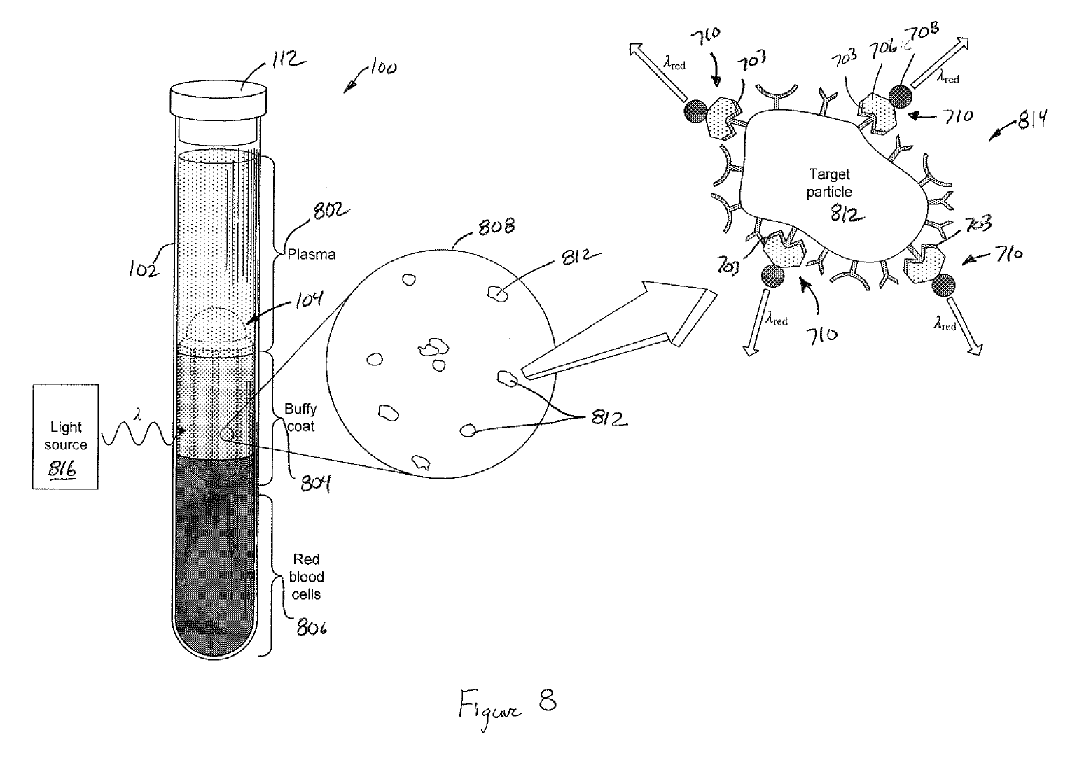

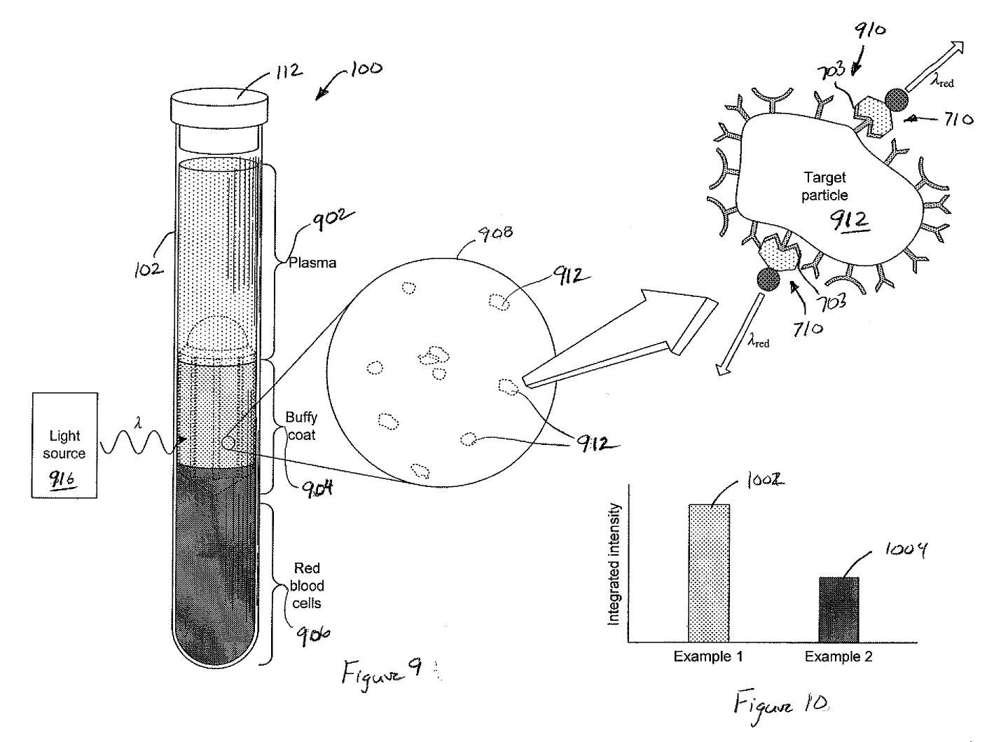

FIG. 6 shows a flow diagram of an example method of preparing a suspension containing target particles. In block 601, a sample suspension of bodily fluid is collected. For example, the sample suspension can be anticoagulated whole blood obtained using a venepuncture procedure. The sample may contain a number of the target particles to be analyzed using a drug/dye complex. Collection of the suspension may also include fixation to prevent autolysis and putrification of the sample. Fixation is usually a multistep process to prepare a sample of biological material for analysis. The choice of fixative and fixation protocol may depend on the additional processing steps and final analyses planned. The fixation process can include well-known physical and chemical fixation processes. FIG. 7A shows an example representation of a target particle 700. The target particle 700 can represent a cell, vesicle, liposome, bacterium, or a naturally occurring or artificially prepared microscopic unit having an enclosed membrane. For example, the target particle 700 can represent a circulating tumor cell (“CTC”), which are cancer cells that have detached from a primary tumor, circulate in the bloodstream, and may be regarded as seeds for subsequent growth of tumors (i.e., metastasis) in different tissues. The example target particle 700 includes three different types of receptors, represented by exaggerated shapes 701-703 extending outward from the membrane 704. Each type of receptor is a molecule capable of attaching a particular type of signaling molecule. A molecule that attaches to a receptor is called a “ligand,” and may be a peptide or other molecule, such as a neurotransmitter, a hormone, a pharmaceutical drug, or a toxin. Each kind of receptor can attach only certain ligand shapes. In other words, each type of receptor functions like a “lock” that opens a signaling pathway only when a proper ligand that functions like a “key” attaches to the receptor. FIG. 7B shows an example of a drug 706 conjugated with a fluorophore 708 to form a drug/dye complex 710. The drug 706 attaches exclusively to the receptors 703, as shown in FIG. 7C. The drug 706 can be a protein or other molecule that is toxic to, or prevents the reproduction of, the target particle 700. For example, the drug 706 can disrupt chemical signaling of the target particle 700 or block the cell surface proteins 703 to prevent another ligand or surface protein necessary for survival or growth of the target particle 700 from binding to the cell surface proteins 703. The dye 708 of the drug/dye complex 710 can be a fluorophore or a chromophore or a quantum dot that emits light in a particular, very narrow wavelength range of the electromagnetic spectrum called a “channel” when an appropriate stimulus is applied. For example, as shown in FIG. 7B, the stimulus can be light with an excitation wavelength that causes the dye 708 to emit light in a red channel of the visible portion of the electromagnetic spectrum. Suitable dyes 708 include, but are not limited to, commercially available dyes, such as fluorescein, R-phycoerythrin (“PE”), Cy5PE, Cy7PE, Texas Red, allophycocyanin, Cy5, Cy7, cascade blue, quantum dots, and Alexa dyes, and combinations of dyes CY5PE, CY7PE, CY7APC.

Returning to FIG. 6, in block 602, a solution containing a drug/dye complex is added to the sample and the sample and drug/dye complex are incubated. The sample and drug/dye complex solution are incubated at an appropriate temperature (e.g., 35° C.) and allowed to interact for a period of time (e.g., less than 24 hours) sufficient to allow the drug/dye complex time to interact with any target particles present in the sample. In block 603, the combined sample and drug/dye complex may be agitated for a period of time sufficient to ensure that the drug/dye complex reacts with the target particles present in the sample. In block 604, the sample interacted with the drug/dye complex is transferred to the tube of a tube and float system, such as the tube and float systems 100 and 120 shown in FIG. 1. In block 605, a float is added to the tube and the cap is attached to seal the open end of the tube. In block 606, the tube, float, and suspension are centrifuged for a period of time sufficient to allow separation of particles suspended in the suspension according to their specific gravities. The float has been selected with a specific gravity that positions the float 104 at approximately the same level as the target particles within the tube.

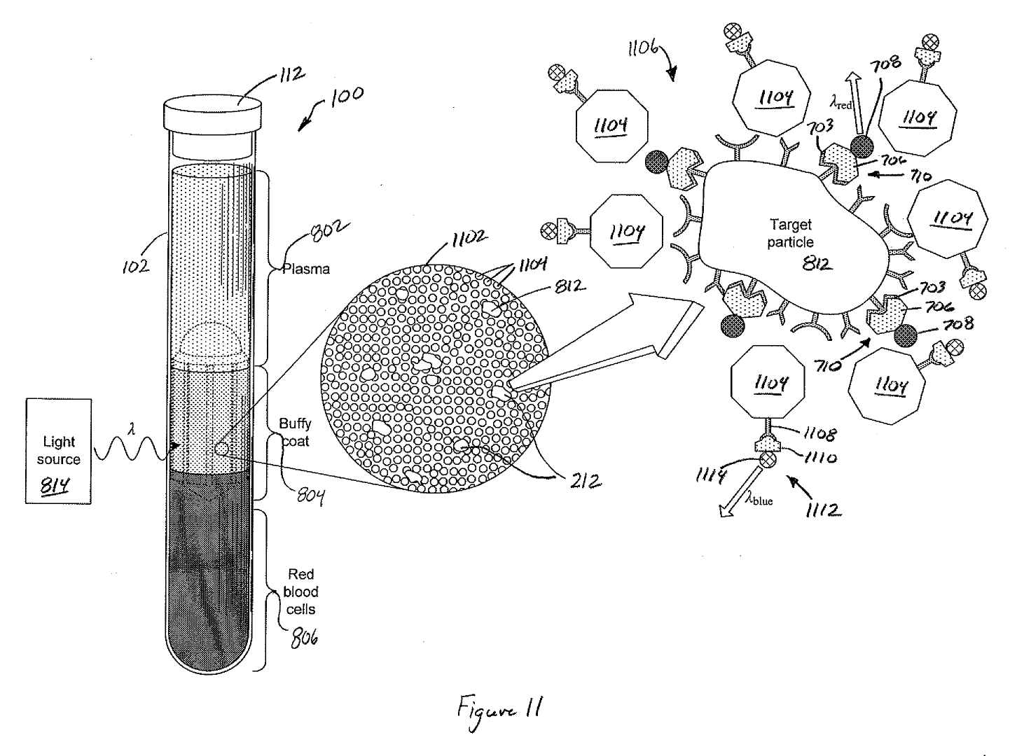

FIG. 8 shows a first example suspension composed of a sample of anticoagulated whole blood combined with the drug/dye complex solution separated into a plasma layer 802, a buffy coat layer 804, and a red blood cell layer 806. The float 104 spreads the buffy coat 804 between the main body of the float 104 and inner wall of the tube 102 with red blood cells 806 packed below the buffy coat 804 and the plasma 802 located above the buffy coat 804. FIG. 8 includes a magnified view 808 of target particles 812 and includes a further magnified view 814 of a single target particle 812 with the drug 706 of the example drug/dye complexes 710 bound to the cell surface proteins 703. Any drug/dye complexes 710 that are not able to attach to target particle surface proteins during incubation migrate to the plasma layer 802 during centrifugation.

Returning to FIG. 6, in block 607, a stimulus is applied to the buffy coat layer. For example, in FIG. 8, when the buffy coat 804 is illuminated with light of an appropriate excitation wavelength from a light source 816, the dye of the drug/dye complexes emit light, such as red light. As a result, the drug/dye complexes 710 attached to the target particles serve as biomarkers for the target particles 812, because the drug/dye complexes that emit light in the buffy coat layer indicate the presence of the target particle in the sample.

Returning to FIG. 6, in block 608, images of the buffy coat are captured and processed. For example, in FIG. 8, while the buffy coat 804 region is illuminated, images of the buffy coat 804 region can be captured and the target particles identified and counted. Integrated intensities can be calculated from the captured images of the buffy coat layer. For example, pixels belonging to the light emitting spots are identified and the remaining pixels are identified as the background. The intensities of the spots are summed, while subtracting the background intensities, to generate an integrated intensity.

When the target particles have few cell surface proteins, such as receptors, for the drug, the integrated intensity of the fluorescent light emitted from the target particles is lower than the integrated intensity of the fluorescent light emitted from target particles having more receptors for the same drug. FIG. 9 shows a second example of a suspension composed of a sample of anticoagulated whole blood combined with the same drug/dye complex described above with reference to FIG. 8. The sample includes target particles that on average have fewer target particles. After centrifugation, the suspension is separated into a plasma layer 902, a buffy coat 904, and a red blood cell layer 906. FIG. 9 includes a magnified view 908 of a region of the buffy coat 904 and a further magnified view 910 of a single target particle 912. Comparing the target particle 912 with the target particle 812, shown in FIG. 8, reveals the target particle 812 has more receptors 703 for attaching the drug/dye complexes 710 than the target particle 912.

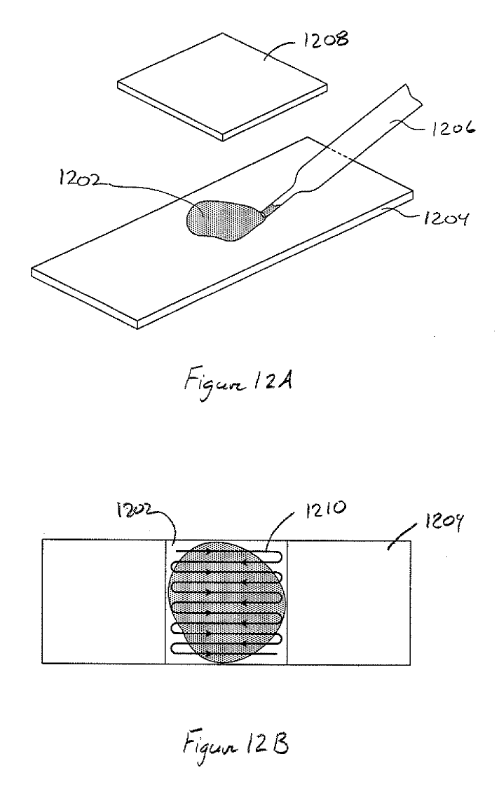

FIG. 10 shows an example of a bar graph of two hypothetical integrated intensities 1002 and 1004 associated with the examples of FIGS. 8 and 9, respectively. The integrated intensity 1004 of the fluorescent target particles 912 shown in FIG. 9 are lower than the integrated intensities of the fluorescent target particles 812 shown in FIG. 8.

The intensities or integrated intensity of the dyes attached to the target particles can also be measured and used to assess the efficacy of a drug used to treat patients. Intensities or integrated intensities that are above a threshold, may be an indication of an effective drug therapy. Otherwise, intensities below the threshold may be considered marginally effective or not effective at all. For example, suppose patients A and B both suffer from prostate cancer and are to be treated with the same drug, such as IGF-1R antibody biologic. The IGF-1R antibody can be conjugated with the dye 708 to form an IGF-1R antibody/dye complex, a solution of which is added to an anticoagulated whole blood sample obtained from patient A and similarly combined with an anticoagulated whole blood sample obtained from patient B. The whole bloods samples obtained from the two patients can be prepared as described above with reference to FIG. 6 with the integrated intensity 1002 corresponding to patient A and integrated intensity corresponding to patient B. The example integrated intensities indicate that it may be assumed that IGF-1R antibody biologic is less effective at treating patient B than it may be for treating patient A.

The example results shown in FIG. 10 can also represent how the efficacy of a drug diminishes over time. For example, cancer cells multiply rapidly. Any genetic mutation that changes the shape of a particular type of receptor that normally attaches a drug designed to destroy the cancer cells enables those cancer cells with the changed receptor to avoid being destroyed by the drug and to proliferate. For example, suppose a patient suffering from breast cancer is treated with IGF-1R antibody biologic, and suppose that the integrated intensity 1002 represents the ability of IGF-1R to bind to the cancer receptors at an earlier time, but the integrated intensity 1004 represents the ability of IGF-1R to bind to the cancer at a later time. Comparison of the integrated intensities 1002 and 1004 may indicate that the patient's breast cancer is evolving away from the IGF-1R antibody biologic and that a different drug may be needed to treat the patient's cancer. For example, a different drug therapy, such as trastuzumab (i.e., Herceptin®), may be selected to treat the patient's breast cancer.

Note that the tube and float system and drug/dye complex enable detection and counting of the target particles without having to separate the target particles from other suspension components. In order to better assess the context or surroundings of the target particles, ligand/dye complexes that attach to cell surface proteins, such as receptors, of non-target particles can also be added to the suspension. For example, as shown in the magnified view 808 of FIG. 8, the target particles 812 may be surrounded by other whole blood components, such as white bloods cells (“WBCs”).

FIG. 11 shows the suspension and tube and float systems described above with reference to FIG. 8 in which target particles are distinguished from non-target particles. The suspension is composed of anticoagulated whole blood combined with the drug/dye complex solution and a ligand/dye complex solution. After centrifugation the suspension is separated into a plasma layer 802, the buffy coat 804, and the red blood cell layer 806. The buffy coat 1104 includes granulocytes, lymphocytes, and monocytes referred to collectively as white blood cells. Magnified view 1102 shows target particles 812 surrounded by WBCs 1104 and reveals that the target particles 812 are in much lower abundance than the WBCs 1104. For example, the target particles 812 can be CTCs. A typical 7.5 ml sample of peripheral whole blood may contain as few as 5 CTCs to be considered clinically relevant in the diagnosis and treatment of a cancer patient. The same sample of whole blood may also contain several million white blood cells and 50 billion red blood cells. In the example of FIG. 11, magnified view 1102 also reveals that although the target particles 812 are considerably larger than the WBCs 1104, the target particles 812 and the WBCs 1104 have approximately the same density because they lie within the approximately the same layer of the buffy coat 1104. FIG. 11 also includes a magnified view 1106 of a single target particle 812 and a few surrounding WBCs 1104. The WBCs 1104 each include a surface protein 1108, such as a receptor, that attaches the ligand 1110 of a ligand/dye complex 1112. The ligand 1110 of the ligand/dye complex 1112 is selected to attach to the WBC receptor 1108, and the dye 1114 of the ligand/dye complex 1112 is selected to emit light in the blue channel of the electromagnetic spectrum. For example, the ligand 1110 can be a CD45 antigen. The ligand/dye complex is a biomarker for the WBCs 1104. As described above, the dyes 708 of the drug/dye complexes emit light in the red channel. As a result, images of the buffy coat 1104 are two channel images that reveal a large number of blue fluorescent particles identifying the larger number of WBCs 1104 surrounding a much smaller number of larger red fluorescent particles identifying the target particles 812.

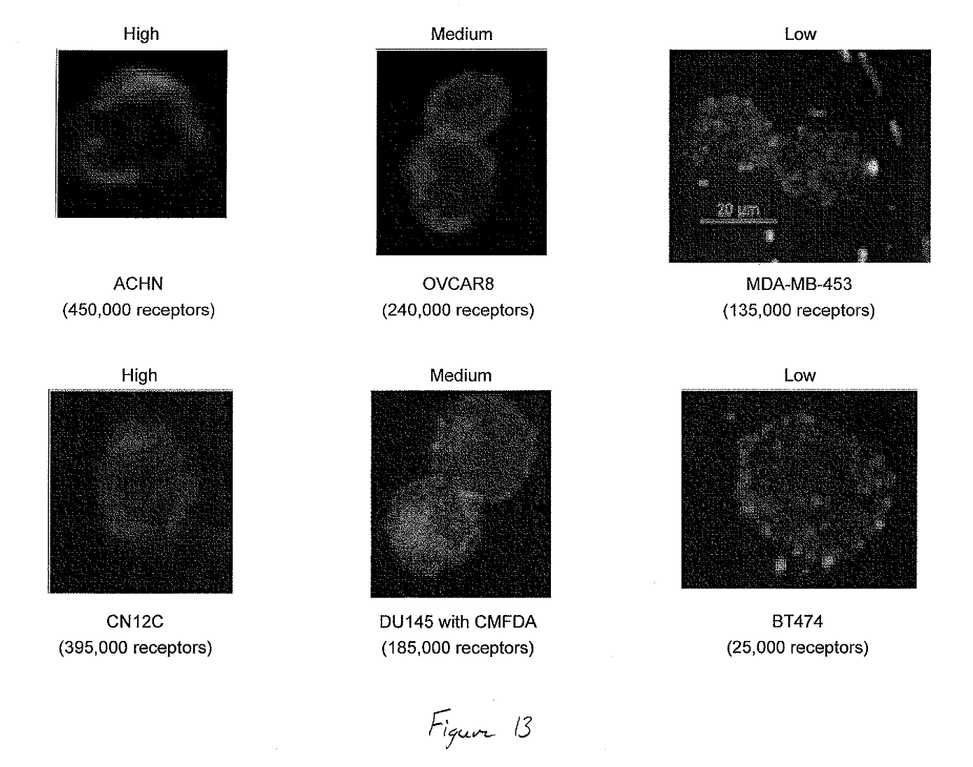

Methods and systems for using a drug as a biomarker are not limited to use with a tube and float system. In other embodiments, a sample of a biological fluid can be combined with a drug/dye complex as described above in blocks 601-603 and the resulting solution 1202 can be placed on a slide 1204 using a pipette 1206, as shown FIG. 12A. A cover slip 1208 can be placed over the solution 1202 and the solution can be raster scanned as represented by serpentine directional line 1210, shown in FIG. 12B, and images of the fluorescing drug/dye complexes acquired using fluorescence microscopy techniques.

### EXAMPLES

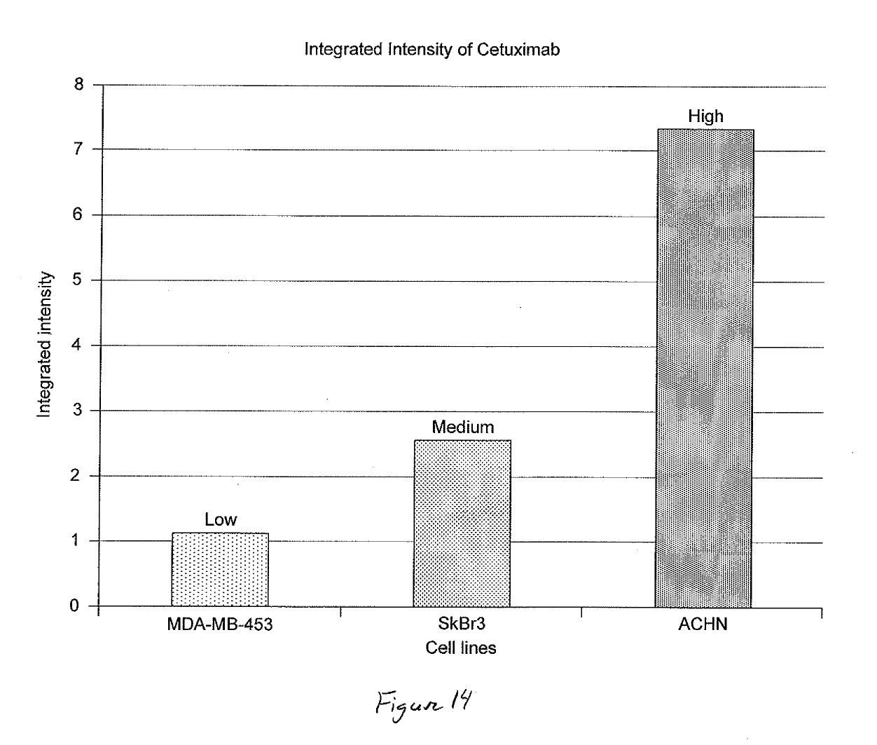

The methods described above were tested with a number of different cancer cell lines that each have different expression levels of epidermal growth factor receptors (“EGFR”). The cancer lines tested were ACHN, OVCAR8, MDA-MB-453, BT474, DU145, SkBr3, and SN12C. Each cell line was separately spiked into a tube containing a peripheral whole blood sample obtained from a non-cancer patient as described above with reference to FIG. 6. Approximately 100 cancer cells were spiked into 3 milliliters of whole blood along with a drug/dye complex composed of an antibody cetuximab (“Erbitux®”) conjugated with the chromophore R-phycoerythrin and the resulting solution was incubated at room temperature for approximately 1 hour. Cetuximab is a chimeric monoclonal antibody, or EGFR inhibitor, often given by intravenous infusion for the treatment of metastatic colorectal cancer and head and neck cancer. The separate cancer cell line solutions were then transferred to separate tubes of tube and float systems, centrifuged, and images of the buffy coat layers were acquired as described with reference to FIG. 6. FIG. 13 shows six images of individual cancer cells of the cancer cell lines ACHN, OVCAR8, MDA-MB-453, CN12C, DU145 labeled with CMFDA, and BT474 treated with the cetuximab/phycoerythrin complex. The images were then processed using well-known image processing techniques to calculate integrated intensities and identify the number of receptors in a given image to which the cetuximab/phycoerythrin complex was bound. For example, in FIG. 13, ACHN was indicated as having a high integrated intensity with approximately 450,000 receptors that bound the cetuximab/phycoerythrin complex, while MDA-MB-453 was indicated as having a low integrated intensity with approximately 135,000 receptors that bound the cetuximab/phycoerythrin complex. FIG. 14 shows a bar graph of actual integrated intensities measured from the images obtained for the cancer cell lines MDA-MB-453, SkBr3, and ACHN combined with the cetuximab/phycoerythrin complex. The graph shows a high integrated intensity for ACHN, medium integrated intensity for SkBr3, and a low integrated intensity for MDA-MB-453. The results presented in FIGS. 13 and 14 may be helpful in predicting a drug's effectiveness for treating certain forms of cancer. For example, the results may be a good indication that cetuximab is be a better drug for treating patients with cells that have expression levels of EGFR closer to the levels of the ACHN cell line than for the MDA-MB-453 cell line. But there are other factors that may influence the effectiveness of a drug, such as mutations of downstream genes. In other words, the experimental results presented in FIGS. 13 and 14 represent data that may help to predict that cetuximab would be an effective drug, but may be only part of the overall data used to assess drug efficacy.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the following claims and their equivalents:

1. A method comprising:
centrifuging a tube that contains a float and a suspension, wherein the suspension contains target particles and drug/dye complexes, wherein the drug of the drug/dye complex is attached to the target particles;
applying a stimulus to the tube, wherein the stimulus causes the dye of the drug/dye complex to emit light in a channel; and
performing image acquisition and image analysis to assess affinity of the drug for the target particle.

2. The method of claim 1, wherein the target particle further comprises one of a cell, vesicle, a liposome, and a bacterium.

3. The method of claim 1, wherein the dye of the drug/dye complex further comprises a fluorophore.

4. The method of claim 1, wherein the dye of the drug/dye complex further comprises a chromophore.

5. The method of claim 1, wherein the dye of the drug/dye complex further comprises a quantum dot.

6. The method of claim 1, wherein the drug further comprises an antibody to attach to a type of protein of the target particle.

7. The method of claim 1, wherein the stimulus further comprises light in a wavelength range that causes the dye to emit light.

8. A method comprising:
centrifuging a tube that contains a float and a suspension, wherein the suspension contains target particles, non-target particles, drug/dye complexes, and ligand/dye complexes, wherein the drug is designed to attach to the target particle and the ligand is designed to attach to certain non-target particles;
applying a stimulus to the tube, wherein the stimulus causes the drug/dye complex to emit light in a first channel and the ligand/dye complex to emit light a second channel; and
performing image acquisition and image analysis to assess affinity of the drug for the target particle.

9. The method of claim 8, wherein the target particle further comprises one of a cell, vesicle, and a liposome.

10. The method of claim 8, wherein the dye of the drug/dye complex further comprises a fluorophore.

11. The method of claim 8, wherein the dye of the drug/dye complex further comprises a chromophore.

12. The method of claim 8, wherein the dye of the drug/dye complex further comprises a quantum dot.

13. The method of claim 8, wherein the drug further comprises an antibody designed to attach to a type of receptor found on the target particle.

14. The method of claim 8, wherein the ligand further comprises a molecule designed to attach to a type of protein found on non-target particles having a similar density to that the target particle.

15. The method of claim 8, wherein the stimulus further comprises light in a wavelength range that causes the dye of the drug/dye complex and dye of the ligand/dye complex to fluoresce.

16. A system for assessing efficacy of a drug, the system comprising:
a surface;
a transparent cover; and
a drug/dye complex to be added to a suspension containing target particles to which a drug of the drug/dye complex binds, wherein when a solution composed of the suspension and drug/dye complex are placed between the surface and the transparent cover and is illuminated with excitation light, the dye emits light with an intensity that reveals binding efficacy of the drug to the target particles.

17. The system of claim 16, wherein the surface is an outer surface of a float and the transparent cover is a wall portion of a tube.

18. The system of claim 16, wherein the surface is a slide and the transparent cover is cover slip.

19. The system of claim 16, wherein the dye of the drug/dye complex further comprises a fluorophore.

20. The system of claim 16, wherein the dye of the drug/dye complex further comprises a chromophore.

21. The system of claim 16, wherein the dye of the drug/dye complex further comprises a quantum dot.

22. The system of claim 16, wherein the drug further comprises an antibody to attach to a type of protein in or on the target particle.
